(19) United States
(12) Patent Application Publication
(10) Pub. No.: US 2022/0343165 A1
(43) Pub. Date: Oct. 27, 2022

(54) DEVICE CAPABILITY AWARE TECHNOLOGY TO EXECUTE DEEP LEARNING COMPUTATION GRAPHS IN WEB APPLICATIONS

(71) Applicant: Intel Corporation, Santa Clara, CA (US)

(72) Inventors: Ningxin Hu, Shanghai (CN); Mohammad Haghighat, San Jose, CA (US); Pinzhen Xu, Shanghai (CN)

(21) Appl. No.: 17/764,094

(22) PCT Filed: Oct. 29, 2019
(86) PCT No.: PCT/CN2019/113932

§ 371 Date: Mar. 25, 2022

(51) Int. Cl. G06N 3/08; G06F 9/48

(52) U.S. Cl. CPC G06N 3/08; G06F 9/4806

(57) ABSTRACT

Systems, apparatuses and methods may provide for technology that detects a request by a web application to execute a neural network and dispatch a first portion of the neural network to a first device via a first process. The technology may also dispatch a second portion of the neural network to a second device via a second process, wherein the second portion of the neural network is to include one or more operations that are unsupported by the first device.

### TECHNICAL FIELD

Embodiments generally relate to machine learning. More particularly, embodiments relate to device capability aware technology to execute deep learning (DL) computation graphs in web applications.

### BACKGROUND

Recent developments in machine learning (ML) technology may facilitate the generation of a neural network computation graph by a web client application (e.g., running on a client device such as a smart phone). Conventional solutions to executing the computation graph, however, may give rise to performance, stability and/or security concerns.

### BRIEF DESCRIPTION OF THE DRAWINGS

The various advantages of the embodiments will become apparent to one skilled in the art by reading the following specification and appended claims, and by referencing the following drawings, in which:

FIG. 1 is a block diagram of an example of a device capability aware computing architecture according to an embodiment;

FIG. 2 is an illustration of an example of a graph partition according to an embodiment;

FIG. 3 is a flowchart of an example of a method of operating a performance-enhanced computing system according to an embodiment;

FIG. 4 is a flowchart of an example of a method of using device capability data to enhance the performance, stability and/or security of a computing system according to an embodiment;

FIGS. 5A and 5B are flowcharts of examples of methods of operating execution backends according to an embodiment;

FIGS. 6A and 6B are illustrations of examples of partitioning results according to embodiments;

FIG. 7 is a block diagram of an example of a performance-enhanced computing system according to an embodiment;

FIG. 8 is an illustration of an example of a semiconductor apparatus according to an embodiment;

FIG. 9 is a block diagram of an example of a processor according to an embodiment; and

FIG. 10 is a block diagram of an example of a multi-processor based computing system according to an embodiment.

### DESCRIPTION OF EMBODIMENTS

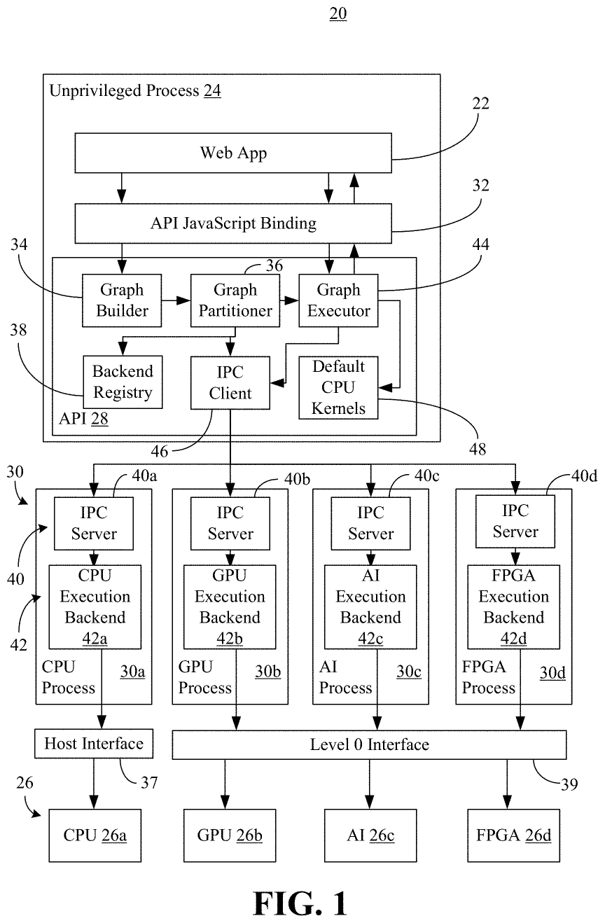

Turning now to FIG. 1, a computing architecture 20 is shown in which a web application 22 (“app”, e.g., web browser, “headless” JAVASCRIPT runtime without a graphical user interface/GUI, native-web hybrid application and/or other web client) is “sandboxed” in an unprivileged process 24. In an embodiment, the architecture 20 is incorporated into a client device such as, for example, a smart phone, tablet device, wearable device, notebook computer, convertible tablet, desktop computer, and so forth. The web application 22 might use a deep learning (DL) neural network to perform operations involving, for example, natural language processing (e.g., text translation), virtual reality (VR), augmented reality (AR), gesture recognition, face recognition, video conferencing, support vector machine (SVM) classification and/or regression, etc., or any combination thereof. In general, the web application 22 may include a web engine as a core component that executes web content written in JAVASCRIPT, HTML (Hypertext Markup Language), CSS (Cascading Style Sheet) and/or other similar language.

In the illustrated example, the architecture 20 includes a plurality of heterogeneous devices 26 (26a-26d) such as, for example, a central processing unit (CPU, e.g., host processor) 26a, a graphics processing unit (GPU, e.g., graphics processor with highly parallel processing capabilities) 26b, an artificial intelligence (AI) accelerator 26c and a field programmable gate array (FPGA) 26d. As will be discussed in greater detail, an application programming interface (API, e.g., Web Neural Network/WebNN API) implementation 28 and a plurality of processes 30 (30a-30d) may be used to dispatch portions (e.g., subgraphs) of the neural network to the devices 26 based on the capabilities of the devices 26 in relation to the operations performed by the neural network. Such an approach enhances the performance, stability and/or security of the architecture 20.

More particularly, a first portion of the neural network may be dispatched to the CPU 26a via a CPU process 30a, a second portion of the neural network might be dispatched to the GPU 26b via a GPU process 30b, a third portion of the neural network may be dispatched to the AI accelerator 26c via an AI process 30c, a fourth portion of the neural network might be dispatched to the FPGA 26d via an FPGA process 30d, and so forth. In an embodiment, the first portion of the neural network includes one or more operations that are either unsupported or less efficient when executed by the GPU 26b, the AI accelerator 26c and/or the FPGA 26d, the second portion of the neural network includes one or more operations that are either unsupported or less efficient when executed by the CPU 26a, the AI accelerator 26c and/or the FPGA 26d, the third portion of the neural network includes one or more operations that are either unsupported or less efficient when executed by the CPU 26a, the GPU 26b and/or the FPGA 26d, and so forth. Accordingly, partitioning the computation graph across the devices 26 based on device capability may enable the architecture 20 to achieve more efficient execution of the neural network, which in turn enhances performance and stability.

Additionally, the processes 30 may be given limited privileges (e.g., minimal privilege and/or least authority) to improve security and stability. For example, the CPU process 30a may be dedicated to the CPU 26a and prevented from accessing the GPU 26b, the AI accelerator 26c and the FPGA 26d. Similarly, the GPU process 30b may be dedicated to the GPU 26b and prevented from accessing the CPU 26a, the AI accelerator 26c and the FPGA 26d. Additionally, the AI process 30c may be dedicated to the AI accelerator 26c and prevented from accessing the CPU 26a, the GPU 26b and the FPGA 26d. Moreover, the FPGA process 30d may be dedicated to the FPGA 26d and prevented from accessing the CPU 26a, the GPU 26b and the AI accelerator 26c. The illustrated solution therefore enhances stability via functionality isolation between the heterogeneous devices 26.

In an embodiment, the processes 30 include respective IPC (inter-process communication) servers 40 (40a-40d) and respective execution backends 42 (42a-42d) to facilitate communications between an IPC client 46 in the API implementation 28 and the devices 26. More particularly, the illustrated CPU process 30a includes a corresponding IPC server 40a and a CPU execution backend 42a, the illustrated GPU process 30b includes a corresponding IPC server 40b and a GPU execution backend 42b, the AI process 30c includes a corresponding IPC server 40c and an AI execution backend 42c, and the FPGA process 30d includes a corresponding IPC server 40d and an FPGA execution backend 42d.

By following a multi-process web engine security model, each execution backend 42 runs inside a dedicated privileged process 30 with access only to the corresponding device 26. Accordingly, if one of the execution backends 42 is compromised, the compromised execution backend 42 can only gain access to the device 26 corresponding to the compromised execution backend 42. The execution backends 42 and the API implementation 28, which runs inside the sandboxed unprivileged process 24, communicate through the IPC servers 40. In one example, the execution backends 42 have three major functionalities: 1) report the supported operators/operations; 2) compile subgraphs; and 3) execute compiled subgraphs. The execution backends 42 may leverage a unified programming model such as, for example, a ONEAPI host interface 37 to implement the above functionalities for the CPU 26a and a ONEAPI Level 0 interface 39 to implement the above functionalities for the GPU 26b, the AI accelerator 26c and the FPGA 26d. When initializing, each execution backend 42 reports the supported operators to a backend registry 38 in the API implementation 28.

When the computation graph corresponding to the neural network is partitioned into subgraphs, each execution backend 42 serves a request to compile a respective subgraph. Each request may contain the topology of the respective subgraph as well as trained data. In one example, the execution backend 42 converts the subgraph from the WebNN format to the format of the native device driver or compiler and compiles the subgraph natively. After compilation is complete, the execution backend 42 generates a key (e.g., index) for the compiled subgraph and sends the key back to a graph partitioner 36 in the API implementation 28. When executing the subgraph, the execution backend 42 serves the request to execute the subgraph, where the request contains the input (e.g., real-time inference) data. In an embodiment, the execution backend 42 passes the input data to a native runtime and dispatches the execution asynchronously. Once the execution is complete, the execution backend 42 retrieves the output data from the corresponding device 26 and sends the output data to a graph executor 44 in the API implementation.

In one example, the backend registry 38 runs inside the unprivileged process 24 and indicates the number and types of execution backends 42 that are available/present in the architecture 20. For example, when the engine of the web application 22 is running on a smartphone, only the CPU execution backend 42a and the GPU execution backend 42b might be present. In another example, when engine of the web application is running on a personal computer (PC), the CPU execution backend 42a, the GPU execution backend 42b, and the AI execution backend 42c may be present. For each available execution backend 42, the execution backend registry 38 may also maintain the supported neural network operators. In this regard, due to hardware or software capability, an execution backend 42 might only support a subset of the entire operator set (e.g., a subset of the WebNN operator set). For example, the AI execution backend 42c may only support ten operators of the entire fifty operators of the WebNN operator set. By contrast, the GPU execution backend 42b might support forty-five operators of the entire fifty.

The illustrated API implementation 28 also includes the graph partitioner 36, which runs inside the unprivileged process 24 and splits the computation graph into subgraphs based on device preference and capability. The graph partitioner 36 may take the computation graph generated by a graph builder 34 as input. In one example, the graph builder 34 is an existing component of the WebNN implementation, where the web application 22 generates a neural network and invokes the API implementation 28 to build a computation graph for the neural network. The web application 22 may then invoke the API implementation 28 to execute the graph. The API implementation 28 may also permit the web application 22 to set device preferences for the graph execution. Thus, the device preferences may be another input to the graph partitioner 36. In an embodiment, the graph partitioner 36 first traverses the computation graph and tags each node with the device 26 that can execute the node. As already noted, the device capability may be stored in the backend registry 38. The example code below provides one approach to tagging the graph.

```
  Given Graph G with N nodes, device preference list PreferenceList and
DeviceRegistry
  Tag(G):
  For each device in PreferenceList:
    Let supportedOps = DeviceRegistry.getSupportedOps(device)
    Foreach node in G.getUnTaggedNodes( ):
      If (node.isTagged( )):
        continue
      If (supportedOps.isSupported(node.op)):
        Tag node with device
```

If the device indicated by the web application 22 can execute all nodes of the graph, the partition result is merely a graph with tagged nodes that indicate the device to execute. Sometimes, however, the device indicated by the web application 22 might not support all nodes of the computation graph. In such a case, the graph partitioner 36 splits the graph into subgraphs, where each subgraph contains the nodes that can be executed by a device. In an embodiment, subgraphs are connected by edges that indicate the tensor (e.g., multidimensional array) to be exchanged between the devices 26. The example code below provides one approach to partitioning a computation graph.

```
  Given TaggedGraph TG with N nodes and T tags
  Partition(TG):
    Let rank[0..N−1] be an array with all zeros
    For each node i in topologicalSort(TG.nodes):
      For each node j in i.parents:
        If node i and j have the same tag values:
          rank[i] <− max(rank[i], rank[j])
        Else:
          rank[i] <− max(rank[i], rank[j] + 1)
  // gather nodes with same rank and tag values
    Let G′ be a new NestedGraph with each node being a subgraph
    For each node i in TG.nodes:
      Add node i to the subgraph with signature (TG.tag[i], rank[i])
    For each node i in TG.nodes:
      For each node j in i.children:
        sigI <− (G.tag[i], rank[i])
        sigJ <− (G.tag[j], rank[j])
        //link subgraphs containing nodes with different
signatures
        If sigI != sigJ:
          G′.addEdge(G′.findSubgraph(sigI),
G′.findSubgraph(sigJ))
  return G′
```

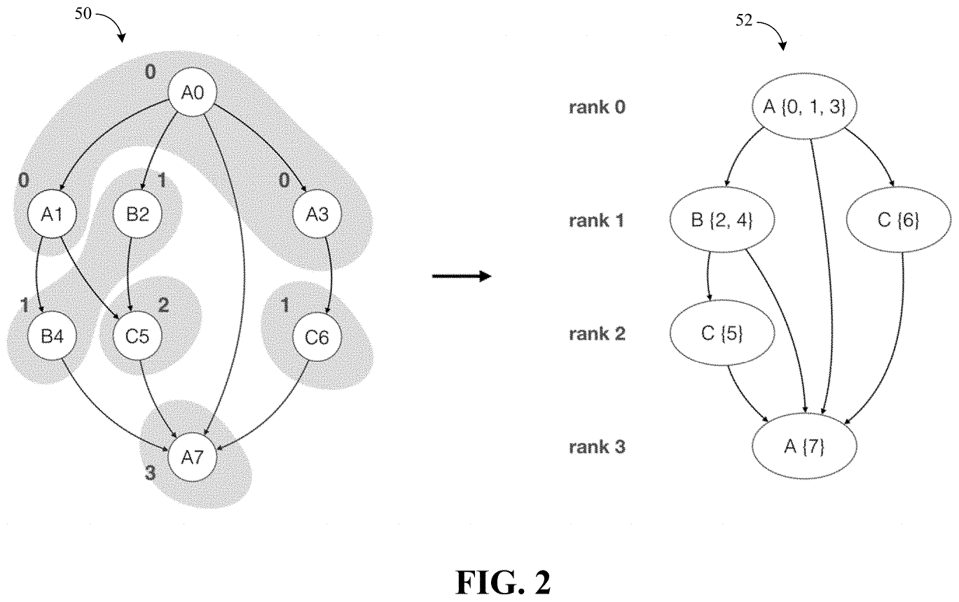

FIG. 2 shows an example of a graph partition in which an initial computation graph 50 is tagged with eight nodes and three tag values {A, B, C}. The tag values A, B and C indicate that the device that can execute a subgraph. The numbers 0-3 next to the nodes are the computed rank values. On the right is a resulting partitioned graph 52, where each node is a subgraph. In the illustrated example, the topmost node (A {0, 1, 3}) is a subgraph containing three nodes {0, 1, 3} with the signature (A, 0) and three outgoing edges to another three subgraphs that are B {2, 4}, A {7} and C {6}.

Returning now to FIG. 1, after partitioning is complete, the illustrated graph partitioner 36 sends each subgraph to the corresponding execution backend 42 for to compilation. Once the compilation is complete, the execution backend 42 may return a key for that compilation graph, where the key is used to reference the compiled graph within the execution backend 42. After this process, the execution backend 42 only keeps an identifier of the device and compiled key tuple (A {key}) for a subgraph inside the partitioned graph (e.g., all of the trained weights in the neural network may be dropped).

The illustrated API implementation 28 also includes the graph executor 44 that runs inside the unprivileged process 24 and handles the execution of the partitioned graph by dispatching the subgraphs to the execution backends 42 through the IPC servers 40. The graph executor 44 may take a partitioned graph from the graph partitioner 36 and maintain an array of workers, where each worker acts as a proxy for the execution backend 42 running the process 30 with limited privileges. In an embodiment, the graph executor 44 traverses the partitioned graph and, for each subgraph, identifies the corresponding worker that is able to execute the subgraph. The graph executor 44 then dispatches the key of the compiled graph through the IPC server 40 to the execution backend 42 for execution. Of particular note is that the graph executor 44 need not wait for any given execution backend 42 to complete. Rather, the execution is handled by each execution backend 42 asynchronously. When the execution backend 42 competes the execution, the execution backend 42 sends a notification back to the corresponding worker in the graph executor 44. When a worker is notified that execution is complete, the graph executor 44 fetches the outputs of the node in question and sets the input of the children of the node in question with the corresponding output of the node. The graph executor 44 may then find the next node with all inputs set for dispatching execution. The example code below shows one approach to executing the computation graph.

```
  Given G′ is the partitioned graph where each node being a subgraph
  Execute(G′):
    Initialize Workers[0..T−1] where T is number of execution backend.
    Foreach node in G′:
      If node.rank == 0:
        Workers[node.tag].dispatch(node.key)
        Mark node as DISPATCHED
  While True:
    node = waitForAnyDone(Workers)
    Mark node as DONE
    Foreach C in node.children:
      Set node.outputs[C] to C.inputs[node]
  If all inputs of C are set and C is not marked as DISPATCHED:
    Workers[C.tag].dispatch(C.key)
  If all nodes are marked DONE:
    Break
```

Returning to FIG. 2, if two subgraphs are not data dependent and can be dispatched to different devices, they may be executed in parallel. For example, after the execution of subgraph A{0, 1, 3}, the subgraph B{2, 4} and subgraph C{6} may be dispatched to Execution Backend B and Execution Backend C, respectively, for execution at the same time. If two subgraphs are to be executed by the same execution backend even though the subgraphs do not have a data dependency, they may be queued into the execution backend and executed sequentially. For example, illustrated subgraphs C{6} and C{5} do not have a data dependency, but will be queued into Execution Backend C, which will execute them one-by-one. If a subgraph cannot be executed by any execution backend, the graph executor may execute the node of that subgraph by invoking the corresponding kernel of one or more default CPU kernels 48 (FIG. 1). This “fallback” execution may run inside an unprivileged process. In an embodiment, the default CPU kernels 48 (FIG. 1) contain a prebuilt binary of the CPU implementation for each WebNN supported operator, where the graph executor can invoke a kernel by setting input data to obtain output data and the kernel execution is synchronized.

Returning now to FIG. 1, during operation, the web application 22 may invoke an API JAVASCRIPT binding 32 to initiate the building of a computation graph in memory by the graph builder 34. In an embodiment, the computation graph represents the neural network as a set of operands, operations and trained weights. The graph partitioner 36 may query the backend registry 38 for information regarding the operations supported by each of the execution backends 42. The illustrated graph partitioner 36 partitions the graph into subgraphs based on the supported operations of each execution backend 42. The graph partitioner 36 may then request that the execution backend 42 compile the subgraph based on the partition result through the IPC client 46.

For example, the AI process 30c may receive a subgraph compilation request to and pass the request to the AI execution backend 42c. The AI execution backend 42c then compiles the subgraph based on, for example, the ONEAPI Level 0 interface for the AI accelerator 26c.

Similarly, the GPU process 30b may receive a subgraph compilation request and pass the request to the GPU execution backend 42b. The illustrated GPU execution backend 42b compiles the subgraph based on, for example, the ONEAPI Level 0 interface for the GPU 26b.

Additionally, the CPU process 30a may receive a subgraph compilation request and pass the request to the CPU execution backend 42a. In an embodiment, the CPU execution backend 42a compiles the subgraph based on, for example, the ONEAPI host interface for the CPU 26a.

The web application 22 may then invoke the graph execution by API implementation 28 with input data to perform real-time operations involving, for example, natural language processing, VR, AR, gesture recognition, face recognition, video conferencing, SVM classification and/or regression, etc., or any combination thereof. The illustrated API JAVASCRIPT binding 32 passes the graph execution request with input data to the graph executor 44, which sends IPC requests to the limited privilege processes 30 that contain the execution backends 42 according to the subgraphs to be executed. For each subgraph execution, the graph executor 44 sends an execution request to the device-dependent process 30 via IPC.

For example, the illustrated AI process 30c receives an execution request and passes the request to the AI execution backend 42c. The AI execution backend 42c sets the input data and asynchronously dispatches the subgraph execution request to the AI accelerator 26c via, for example, the ONEAPI Level 0 interface. Then, the AI accelerator 26c computes and when computation is complete, the AI accelerator 26c notifies the AI execution backend 42c. In response to the notification, the AI execution backend 42c may retrieve the output data and send the output data back to the graph executor 44 through IPC.

Similarly, the GPU process 30b may receive an execution request and pass the request to the GPU execution backend 42b. The GPU execution backend 42b sets the input data and asynchronously dispatches the subgraph execution request to the GPU 26b through, for example, the ONEAPI Level 0 interface. Then, the GPU 26b computes and when computation is complete, the illustrated GPU 26b notifies GPU execution backend 42b. In response to the notification, the GPU execution backend retrieves the output data and sends the output data back to the graph executor 44 through IPC.

Additionally, the illustrated CPU process 30a receives an execution request and passes the request to the CPU execution backend 42a. In an embodiment, the CPU execution backend 42a sets the input data and asynchronously executes the compiled code on the CPU 26a for the subgraph. When the CPU 26a computation completes, the CPU 26a notifies the CPU execution backend 42a. In response to the notification, the CPU execution backend 42a may retrieve the output data and send the output data back to the graph executor 44 through IPC.

If there are remaining operations that are not supported by any execution backend 42, the illustrated graph executor 44 executes the unsupported operations via the default CPU kernels 48. In an embodiment, the graph executor 44 returns the final graph output to the API JAVASCRIPT binding 32, which passes the final graph output to the web application 22 (e.g., user code).

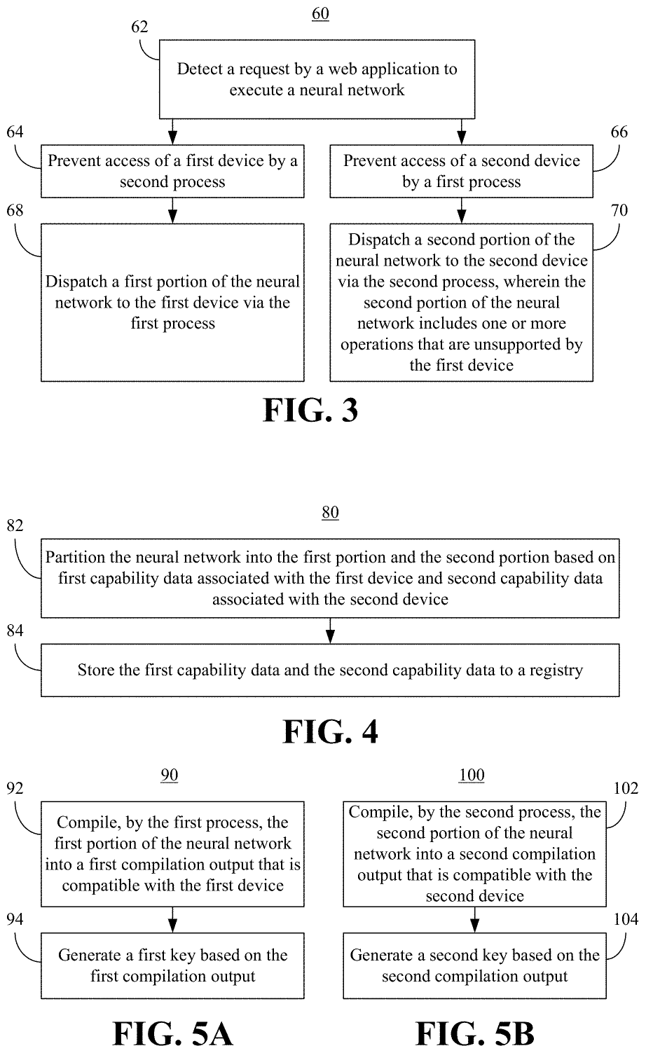

FIG. 3 shows a method 60 of operating a performance-enhanced computing system. The method 60 may generally be implemented in a device capability aware computing architecture such as, for example, the computing architecture 20 (FIG. 1), already discussed. More particularly, the method 60 may be implemented as one or more modules in a set of logic instructions stored in a machine- or computer-readable storage medium such as random access memory (RAM), read only memory (ROM), programmable ROM (PROM), firmware, flash memory, etc., in configurable logic such as, for example, programmable logic arrays (PLAs), FPGAs, complex programmable logic devices (CPLDs), in fixed-functionality hardware logic using circuit technology such as, for example, application specific integrated circuit (ASIC), complementary metal oxide semiconductor (CMOS) or transistor-transistor logic (TTL) technology, or any combination thereof.

For example, computer program code to carry out operations shown in the method 60 may be written in any combination of one or more programming languages, including an object oriented programming language such as JAVA, SMALLTALK, C++ or the like and conventional procedural programming languages, such as the “C” programming language or similar programming languages. Additionally, logic instructions might include assembler instructions, instruction set architecture (ISA) instructions, machine instructions, machine dependent instructions, microcode, state-setting data, configuration data for integrated circuitry, state information that personalizes electronic circuitry and/or other structural components that are native to hardware (e.g., host processor, central processing unit/CPU, microcontroller, etc.).

Illustrated processing block 62 provides for detecting a request by a web application (e.g., web browser, headless JAVASCRIPT runtime, native-web hybrid application and/or other web client) to execute a neural network. Block 62 may include detecting that the web application has invoked an API JAVASCRIPT binding. Other approaches to detecting the request to execute the neural network may also be used. In an embodiment, the neural network performs real-time operations involving, for example, natural language processing, VR, AR, gesture recognition, face recognition, video conferencing, SVM classification and/or regression, etc., or any combination thereof. Block 64 prevents access of a first device (e.g., CPU) by a second process (e.g., GPU process) and block 66 prevents access of a second device (e.g., GPU) by a first process (e.g., CPU process). Blocks 64 and 66, which enhance security and performance, may be performed by any suitable component having system level privileges (e.g., Ring 0, trusted execution and/or secure boot component). In the illustrated example, block 68 dispatches a first portion (e.g., first subgraph) of the neural network to the first device via the first process. Additionally, block 70 may dispatch a second portion (e.g., second subgraph) of the neural network to the second device via the second process.

In an embodiment, the second portion of the neural network includes one or more operations that are unsupported by the first device. Similarly, the first portion of the neural network may include one or more operations that are unsupported by the second device. In this regard, an operation/operator may specify the computations to be performed, with each operation including an operation type, a list of indexes of the operands that the operation uses for input, and a list of indexes of the operands that the operation uses for output. Operations might include, for example, element-wise mathematical operations, tensor manipulations, image operations, lookup operations, normalization operations, convolution operations, pooling operations, activation operations, and so forth. Moreover, different APIs may support different types of operations.

For example, the WebNN API is based on the intersection set of ANDROID NN (neural network) operations and ONNX (Open Neural Network Exchange) NN operators. Thus, the second device (e.g., and corresponding execution backend) might be limited to WebNN operability and therefore lack support for operations in the neural network that are outside the intersection set (e.g., operators in the ONNX NN but not in the ANDROID NN). In such a case, if the first device (e.g., and corresponding execution backend) does support operations in the neural network that are outside the intersection set, the portion (e.g., subgraph) of the neural network that contains the operations in the neural network that are outside the intersection set may be dispatched to the first device. Such an approach enhances performance and stability.

FIG. 4 shows a method 80 of using device capability data to enhance the performance, stability and/or security of a computing system. The method 80 may generally be incorporated into blocks 62, 68 and/or 70 (FIG. 3), already discussed. More particularly, the method 80 may be implemented as one or more modules in a set of logic instructions stored in a machine- or computer-readable storage medium such as RAM, ROM, PROM, firmware, flash memory, etc., in configurable logic such as, for example, PLAs, FPGAs, CPLDs, in fixed-functionality hardware logic using circuit technology such as, for example, ASIC, CMOS or TTL technology, or any combination thereof.

Illustrated processing block 82 provides for partitioning the neural network into the first portion and the second portion based on first capability data associated with the first device and second capability data associated with the second device. In an embodiment, the capability data indicates the operations and/or operators supported by the devices, the respective execution backends and/or respective limited-privileged processes. The first capability data and the second capability data may be stored at block 84 to a registry such as, for example, the backend registry 38 (FIG. 1), already discussed. The illustrated method 80 therefore further enhances stability by enabling the unprivileged API to determine more efficient partitioning and execution of the neural network.

FIG. 5A shows a method 90 of operating a first execution backend. The method 90 may generally implemented in a device capability aware computing architecture such as, for example, the computing architecture 20 (FIG. 1), already discussed. More particularly, the method 90 may be implemented as one or more modules in a set of logic instructions stored in a machine- or computer-readable storage medium such as RAM, ROM, PROM, firmware, flash memory, etc., in configurable logic such as, for example, PLAs, FPGAs, CPLDs, in fixed-functionality hardware logic using circuit technology such as, for example, ASIC, CMOS or TTL technology, or any combination thereof. Illustrated processing block 92 provides for compiling, by the first process, the first portion of the neural network into a first compilation result that is compatible with the first device. Additionally, a first key may be generated at block 94 based on the first compilation output. In an embodiment, the first key enables more efficient operation by reducing the amount of data transfer between the execution backend and the API implementation.

FIG. 5B shows a method 100 of operating a second execution backend. The method 100 may generally implemented in a device capability aware computing architecture such as, for example, the computing architecture 20 (FIG. 1), already discussed. More particularly, the method 100 may be implemented as one or more modules in a set of logic instructions stored in a machine- or computer-readable storage medium such as RAM, ROM, PROM, firmware, flash memory, etc., in configurable logic such as, for example, PLAs, FPGAs, CPLDs, in fixed-functionality hardware logic using circuit technology such as, for example, ASIC, CMOS or TTL technology, or any combination thereof.

Illustrated processing block 102 provides for compiling, by the second process, the second portion of the neural network into a second compilation result that is compatible with the second device. Additionally, a second key may be generated at block 104 based on the first compilation output. Again, the second key may enable more efficient operation by reducing the amount of data transfer between the execution backend and the API implementation.

Experimental configurations were created using the MobileNet neural network and a MKL-DNN (Math Kernel Library for Deep Neural Networks) based CPU execution backend and default CPU kernels in WebAssembly in a CHROMIUM browser. In an embodiment, WebAssembly is an open standard that defines a portable binary code format for executable programs and a corresponding textual assembly language, as well as interfaces to facilitate interactions between such programs and the associated host environments. The MobileNet topology contains 15×Conv2D layers, 13×DepthwiseConv2D layers, 1×AveragePool2D layer, 1×Softmax layer and 1×Squeeze layers. The experimental configurations are shown in Table I below.

TABLE I

| Configuration | Execution Backend | |
|---|---|---|
| # | Supported Operators | Remarks |
| 1 | None | None |
| 2 | Conv2D | Conv2D |
| 3 | Conv2D, | Conv2D, |
| | DepthwiseConv2D | DepthwiseConv2D |
| 4 | Conv2D, | Conv2D, |
| | DepthwiseConv2D, | DepthwiseConv2D, |
| | AveragePool2D, | AveragePool2D, |
| | Softmax, Squeeze | Softmax, Squeeze |
| 5 | Conv2D, | Conv2D, |
| | DepthwiseConv2D, | DepthwiseConv2D, |
| | AveragePool2D, | AveragePool2D, |
| | Softmax, Squeeze | Softmax, Squeeze |
| | (without graph | (without graph |
| | partition & execution) | partition & execution) |

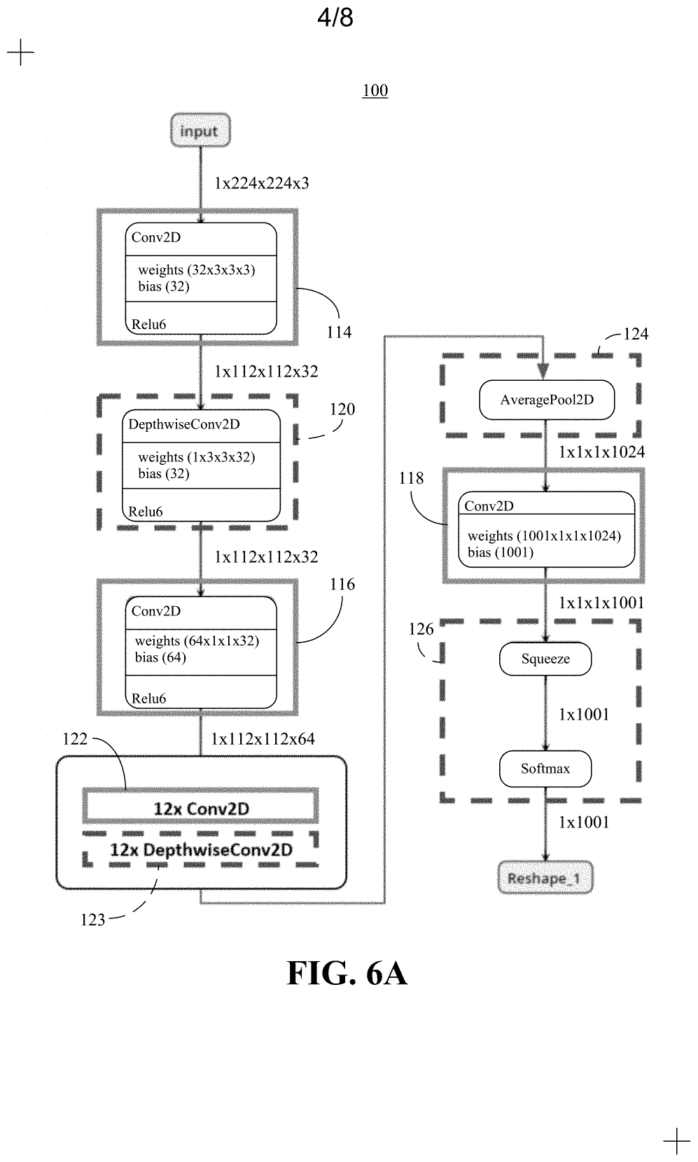

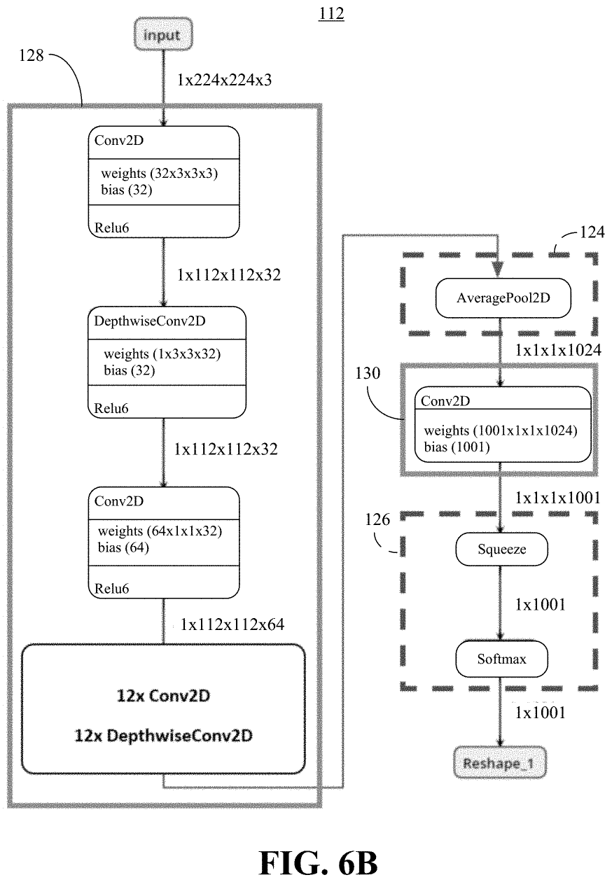

FIGS. 6A and 6B demonstrate results 110 (Configuration #2) and 112 (Configuration #3), respectively. In the result 110, the neural network is partitioned into thirty subgraphs. Among them, subgraphs 114, 116, 118 and 122 (e.g., 15×Conv2D) are executed by the CPU execution backend and the remaining subgraphs 120, 122, 123, 124 and 126 are executed by the default CPU kernels. In the result 112, the neural network is partitioned into four subgraphs. Among them, subgraphs 128 and 130 are executed by the CPU execution backend and the remaining subgraphs 124 and 126 are executed by the default CPU kernels. The inference times for Configuration #2-#4 were all significantly less than the inference time for Configuration #1 and #5. Thus, the solution described herein can partition and execute the WebNN computation graph based on the device capability. Moreover, the performance scales with the capability (supported operators) of an execution backend. For example, 5× speedup was observed with one operation (Configuration #2) support and 33× speedup was observed with two operations (Configuration #3) support. Additionally, the solution (e.g., graph-based execution) outperforms existing command-based execution. For example, graph-based execution (Configuration #4) was 3× faster than command-based execution (Configuration #5).

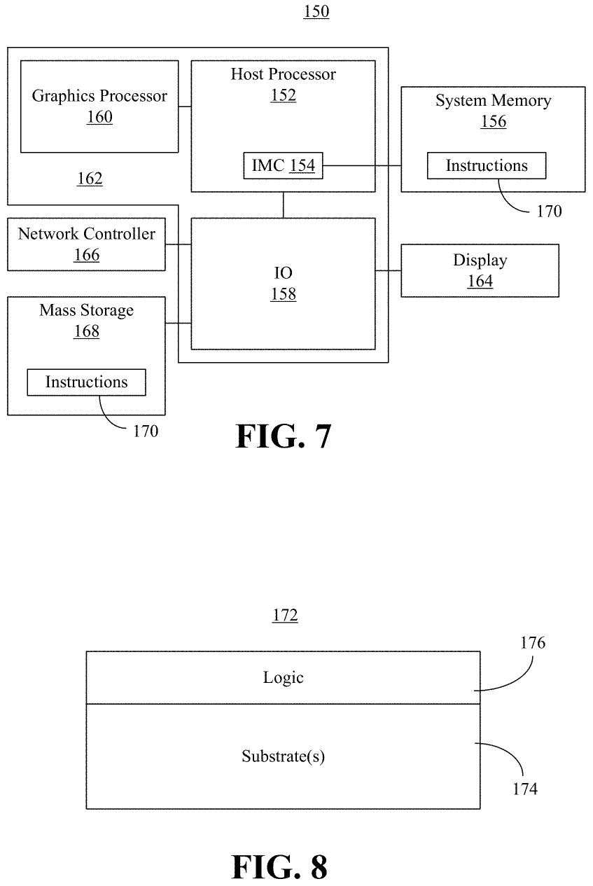

Turning now to FIG. 7, a performance-enhanced computing system 150 is shown. The system 150 may generally be part of an electronic device/platform having computing functionality (e.g., personal digital assistant/PDA, notebook computer, tablet computer, convertible tablet, server), communications functionality (e.g., smart phone), imaging functionality (e.g., camera, camcorder), media playing functionality (e.g., smart television/TV), wearable functionality (e.g., watch, eyewear, headwear, footwear, jewelry), vehicular functionality (e.g., car, truck, motorcycle), robotic functionality (e.g., autonomous robot), etc., or any combination thereof. In the illustrated example, the system 150 includes a host processor 152 (e.g., CPU, first device) having an integrated memory controller (IMC) 154 that is coupled to a system memory 156.

The illustrated system 150 also includes an input output (10) module 158 implemented together with the host processor 152 and a graphics processor 160 (e.g., GPU, second device) on a semiconductor die 162 as a system on chip (SoC). The illustrated 10 module 158 communicates with, for example, a display 164 (e.g., touch screen, liquid crystal display/LCD, light emitting diode/LED display), a network controller 166 (e.g., wired and/or wireless), and mass storage 168 (e.g., hard disk drive/HDD, optical disk, solid state drive/SSD, flash memory). In one example, the network controller 66 obtains remote data (e.g., from a web server) in response to one or more requests from a web application.

In an embodiment, the host processor 152, the graphics processor 160 and/or the 10 module 158 execute program instructions 170 retrieved from the system memory 156 and/or the mass storage 168 to perform one or more aspects of the method 60 (FIG. 3), the method 80 (FIG. 4), the method 90 (FIG. 5A) and/or the method 100 (FIG. 5B), already discussed. Thus, execution of the illustrated instructions 170 may cause the computing system 150 to detect a request (e.g., invocation of an API JAVASCRIPT binding) by the web application to execute a neural network. Execution of the instructions 170 may also cause the computing system 150 to dispatch a first portion of the neural network to the host processor 152 via a first process and dispatch a second portion of the neural network to the graphics processor 160 via a second process. In one example, the second portion of the neural network includes one or more operations that are unsupported by the host processor 152. Additionally, the first portion of the neural network may include one or more operations that are unsupported by the graphics processor 160. In an embodiment, the first portion of the neural network is a first subgraph and the second portion of the neural network is a second subgraph.

Execution of the instructions 170 may also cause the computing system 150 to prevent access of the host processor 152 by the second process and prevent access of the graphics processor 160 by the first process. Moreover, execution of the instructions 170 may cause the computing system 150 to partition the neural network into the first portion and the second portion based on first capability data associated with the host processor 152 and second capability data associated with the graphics processor 160. Additionally, the instructions 170 may store the first and second capability data to a registry.

In an embodiment, execution of the instructions 170 causes the computing system to compile, by the first process, the first portion of the neural network into a first compilation output that is compatible with the host processor 152 and generate a first key based on the first compilation output. Similarly, the instructions 170 may compile, by the second process, the second portion of the neural network into a second compilation output that is compatible with the second device and generate a second key based on the second compilation output.

The computing system 150 may therefore be considered performance-enhanced to the extent that operations of the neural network are dispatched to more efficient and stable execution resources. Additionally, greater security may be achieved by ensuring that the compilation and execution processes corresponding to the devices have limited privileges.

FIG. 8 shows a semiconductor apparatus 172 (e.g., chip, die, package). The illustrated apparatus 172 includes one or more substrates 174 (e.g., silicon, sapphire, gallium arsenide) and logic 176 (e.g., transistor array and other integrated circuit/IC components) coupled to the substrate(s) 174. In an embodiment, the logic 176 implements one or more aspects of the method 60 (FIG. 3), the method 80 (FIG. 4), the method 90 (FIG. 5A) and/or the method 100 (FIG. 5B), already discussed. Thus, the logic 176 may detect a request by a web application to execute a neural network and dispatch a first portion of the neural network to a first device via a first process. The logic 176 may also dispatch a second portion of the neural network to a second device via a second process, wherein the second portion of the neural network includes one or more operations that are unsupported by the first device.

The apparatus 172 may therefore be considered to be performance-enhanced at least to the extent that operations of the neural network are dispatched to more efficient and stable execution resources. Additionally, greater security may be achieved by ensuring that the compilation and execution processes corresponding to the devices have limited privileges.

The logic 176 may be implemented at least partly in configurable logic or fixed-functionality hardware logic. In one example, the logic 176 includes transistor channel regions that are positioned (e.g., embedded) within the substrate(s) 174. Thus, the interface between the logic 176 and the substrate(s) 174 may not be an abrupt junction. The logic 176 may also be considered to include an epitaxial layer that is grown on an initial wafer of the substrate(s) 174.

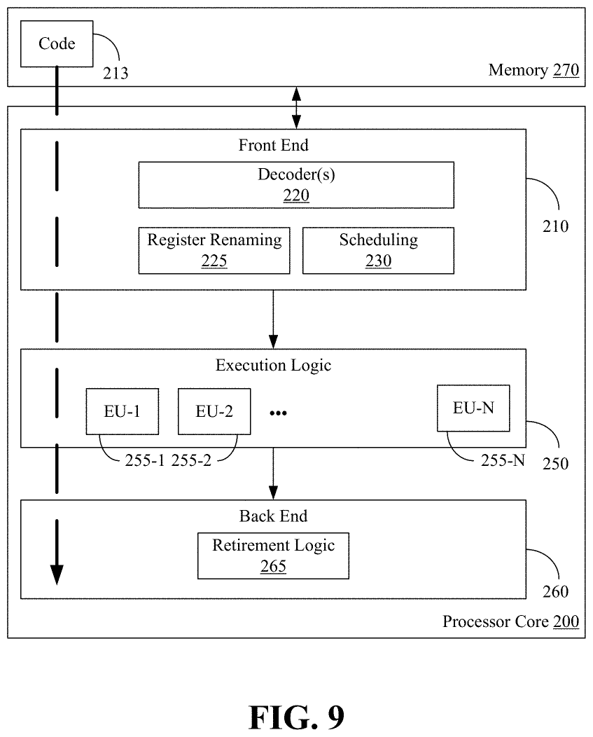

FIG. 9 illustrates a processor core 200 according to one embodiment. The processor core 200 may be the core for any type of processor, such as a micro-processor, an embedded processor, a digital signal processor (DSP), a network processor, or other device to execute code. Although only one processor core 200 is illustrated in FIG. 9, a processing element may alternatively include more than one of the processor core 200 illustrated in FIG. 9. The processor core 200 may be a single-threaded core or, for at least one embodiment, the processor core 200 may be multithreaded in that it may include more than one hardware thread context (or “logical processor”) per core.

FIG. 9 also illustrates a memory 270 coupled to the processor core 200. The memory 270 may be any of a wide variety of memories (including various layers of memory hierarchy) as are known or otherwise available to those of skill in the art. The memory 270 may include one or more code 213 instruction(s) to be executed by the processor core 200, wherein the code 213 may implement the method 60 (FIG. 3), the method 80 (FIG. 4), the method 90 (FIG. 5A) and/or the method 100 (FIG. 5B), already discussed. The processor core 200 follows a program sequence of instructions indicated by the code 213. Each instruction may enter a front end portion 210 and be processed by one or more decoders 220. The decoder 220 may generate as its output a micro operation such as a fixed width micro operation in a predefined format, or may generate other instructions, microinstructions, or control signals which reflect the original code instruction. The illustrated front end portion 210 also includes register renaming logic 225 and scheduling logic 230, which generally allocate resources and queue the operation corresponding to the convert instruction for execution.

The processor core 200 is shown including execution logic 250 having a set of execution units 255-1 through 255-N. Some embodiments may include a number of execution units dedicated to specific functions or sets of functions. Other embodiments may include only one execution unit or one execution unit that can perform a particular function. The illustrated execution logic 250 performs the operations specified by code instructions.

After completion of execution of the operations specified by the code instructions, back end logic 260 retires the instructions of the code 213. In one embodiment, the processor core 200 allows out of order execution but requires in order retirement of instructions. Retirement logic 265 may take a variety of forms as known to those of skill in the art (e.g., re-order buffers or the like). In this manner, the processor core 200 is transformed during execution of the code 213, at least in terms of the output generated by the decoder, the hardware registers and tables utilized by the register renaming logic 225, and any registers (not shown) modified by the execution logic 250.

Although not illustrated in FIG. 9, a processing element may include other elements on chip with the processor core 200. For example, a processing element may include memory control logic along with the processor core 200. The processing element may include I/O control logic and/or may include I/O control logic integrated with memory control logic. The processing element may also include one or more caches.

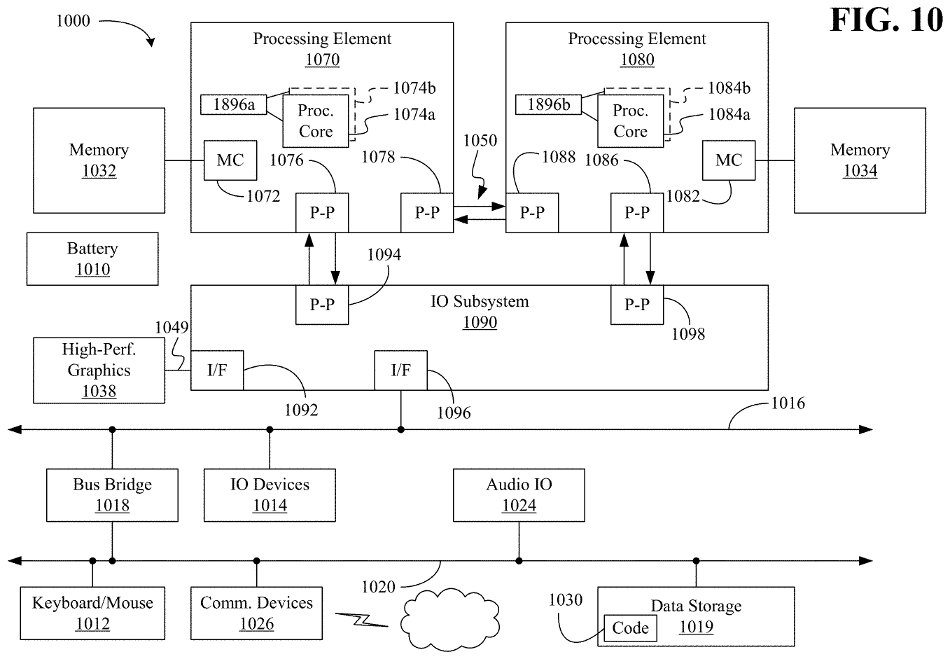

Referring now to FIG. 10, shown is a block diagram of a computing system 1000 embodiment in accordance with an embodiment. Shown in FIG. 10 is a multiprocessor system 1000 that includes a first processing element 1070 and a second processing element 1080. While two processing elements 1070 and 1080 are shown, it is to be understood that an embodiment of the system 1000 may also include only one such processing element.

The system 1000 is illustrated as a point-to-point interconnect system, wherein the first processing element 1070 and the second processing element 1080 are coupled via a point-to-point interconnect 1050. It should be understood that any or all of the interconnects illustrated in FIG. 10 may be implemented as a multi-drop bus rather than point-to-point interconnect.

As shown in FIG. 10, each of processing elements 1070 and 1080 may be multicore processors, including first and second processor cores (i.e., processor cores 1074a and 1074b and processor cores 1084a and 1084b). Such cores 1074a, 1074b, 1084a, 1084b may be configured to execute instruction code in a manner similar to that discussed above in connection with FIG. 9.

Each processing element 1070, 1080 may include at least one shared cache 1896a, 1896b. The shared cache 1896a, 1896b may store data (e.g., instructions) that are utilized by one or more components of the processor, such as the cores 1074a, 1074b and 1084a, 1084b, respectively. For example, the shared cache 1896a, 1896b may locally cache data stored in a memory 1032, 1034 for faster access by components of the processor. In one or more embodiments, the shared cache 1896a, 1896b may include one or more mid-level caches, such as level 2 (L2), level 3 (L3), level 4 (L4), or other levels of cache, a last level cache (LLC), and/or combinations thereof.

While shown with only two processing elements 1070, 1080, it is to be understood that the scope of the embodiments are not so limited. In other embodiments, one or more additional processing elements may be present in a given processor. Alternatively, one or more of processing elements 1070, 1080 may be an element other than a processor, such as an accelerator or a field programmable gate array. For example, additional processing element(s) may include additional processors(s) that are the same as a first processor 1070, additional processor(s) that are heterogeneous or asymmetric to processor a first processor 1070, accelerators (such as, e.g., graphics accelerators or digital signal processing (DSP) units), field programmable gate arrays, or any other processing element. There can be a variety of differences between the processing elements 1070, 1080 in terms of a spectrum of metrics of merit including architectural, micro architectural, thermal, power consumption characteristics, and the like. These differences may effectively manifest themselves as asymmetry and heterogeneity amongst the processing elements 1070, 1080. For at least one embodiment, the various processing elements 1070, 1080 may reside in the same die package.

The first processing element 1070 may further include memory controller logic (MC) 1072 and point-to-point (P-P) interfaces 1076 and 1078. Similarly, the second processing element 1080 may include a MC 1082 and P-P interfaces 1086 and 1088.

As shown in FIG. 10, MC's 1072 and 1082 couple the processors to respective memories, namely a memory 1032 and a memory 1034, which may be portions of main memory locally attached to the respective processors. While the MC 1072 and 1082 is illustrated as integrated into the processing elements 1070, 1080, for alternative embodiments the MC logic may be discrete logic outside the processing elements 1070, 1080 rather than integrated therein.

The first processing element 1070 and the second processing element 1080 may be coupled to an I/O subsystem 1090 via P-P interconnects 1076 1086, respectively. As shown in FIG. 10, the I/O subsystem 1090 includes P-P interfaces 1094 and 1098. Furthermore, I/O subsystem 1090 includes an interface 1092 to couple I/O subsystem 1090 with a high performance graphics engine 1038. In one embodiment, bus 1049 may be used to couple the graphics engine 1038 to the I/O subsystem 1090. Alternately, a point-to-point interconnect may couple these components.

In turn, I/O subsystem 1090 may be coupled to a first bus 1016 via an interface 1096. In one embodiment, the first bus 1016 may be a Peripheral Component Interconnect (PCI) bus, or a bus such as a PCI Express bus or another third generation I/O interconnect bus, although the scope of the embodiments are not so limited.

As shown in FIG. 10, various I/O devices 1014 (e.g., biometric scanners, speakers, cameras, sensors) may be coupled to the first bus 1016, along with a bus bridge 1018 which may couple the first bus 1016 to a second bus 1020. In one embodiment, the second bus 1020 may be a low pin count (LPC) bus. Various devices may be coupled to the second bus 1020 including, for example, a keyboard/mouse 1012, communication device(s) 1026, and a data storage unit 1019 such as a disk drive or other mass storage device which may include code 1030, in one embodiment. The illustrated code 1030 may implement the method 60 (FIG. 3), the method 80 (FIG. 4), the method 90 (FIG. 5A) and/or the method 100 (FIG. 5B), already discussed, and may be similar to the code 213 (FIG. 9), already discussed. Further, an audio I/O 1024 may be coupled to second bus 1020 and a battery 1010 may supply power to the computing system 1000.

Note that other embodiments are contemplated. For example, instead of the point-to-point architecture of FIG. 10, a system may implement a multi-drop bus or another such communication topology. Also, the elements of FIG. 10 may alternatively be partitioned using more or fewer integrated chips than shown in FIG. 10.

### Additional Notes and Examples

Example 1 includes a performance-enhanced computing system comprising a first device, a second device, a network controller to obtain remote data in response to one or more requests from a web application, a processor coupled to the network controller, and a memory coupled to the processor, wherein the memory includes a set of executable program instructions, which when executed by the processor, cause the computing system to detect a request by the web application to execute a neural network, dispatch a first portion of the neural network to the first device via a first process, and dispatch a second portion of the neural network to the second device via a second process, wherein the second portion of the neural network is to include one or more operations that are unsupported by the first device.

Example 2 includes the computing system of Example 1, wherein the program instructions, when executed, further cause the computing system to prevent access of the first device by the second process, and prevent access of the second device by the first process.

Example 3 includes the computing system of Example 1, wherein the program instructions, when executed, further cause the computing system to partition the neural network into the first portion and the second portion based on first capability data associated with the first device and second capability data associated with the second device, and store the first capability data and the second capability data to a registry.

Example 4 includes the computing system of Example 1, wherein the first portion of the neural network is to be a first subgraph and the second portion of the neural network is to be a second subgraph.

Example 5 includes the computing system of Example 1, wherein the program instructions, when executed, further cause the computing system to compile, by the first process, the first portion of the neural network into a first compilation output that is compatible with the first device, generate a first key based on the first compilation output, compile, by the second process, the second portion of the neural network into a second compilation output that is compatible with the second device, and generate a second key based on the second compilation output.

Example 6 includes the computing system of any one of Examples 1 to 5, wherein the first portion of the neural network is to include one or more operations that are unsupported by the second device.

Example 7 includes a semiconductor apparatus comprising one or more substrates, and logic coupled to the one or more substrates, wherein the logic is implemented at least partly in one or more of configurable logic or fixed-functionality hardware logic, the logic coupled to the one or more substrates to detect a request by a web application to execute a neural network, dispatch a first portion of the neural network to a first device via a first process, and dispatch a second portion of the neural network to a second device via a second process, wherein the second portion of the neural network is to include one or more operations that are unsupported by the first device.

Example 8 includes the semiconductor apparatus of Example 7, wherein the logic coupled to the one or more substrates is to prevent access of the first device by the second process, and prevent access of the second device by the first process.

Example 9 includes the semiconductor apparatus of Example 7, wherein the logic coupled to the one or more substrates is to partition the neural network into the first portion and the second portion based on first capability data associated with the first device and second capability data associated with the second device, and store the first capability data and the second capability data to a registry.

Example 10 includes the semiconductor apparatus of Example 7, wherein the first portion of the neural network is to be a first subgraph and the second portion of the neural network is to be a second subgraph.

Example 11 includes the semiconductor apparatus of Example 7, wherein logic coupled to the one or more substrates is to compile, by the first process, the first portion of the neural network into a first compilation output that is compatible with the first device, generate a first key based on the first compilation output, compile, by the second process, the second portion of the neural network into a second compilation output that is compatible with the second device, and generate a second key based on the second compilation output.

Example 12 includes the semiconductor apparatus of any one of Examples 7 to 11, wherein the first portion of the neural network is to include one or more operations that are unsupported by the second device.

Example 13 includes at least one computer readable storage medium comprising a set of executable program instructions, which when executed by a computing system, cause the computing system to detect a request by a web application to execute a neural network, dispatch a first portion of the neural network to a first device via a first process, and dispatch a second portion of the neural network to a second device via a second process, wherein the second portion of the neural network is to include one or more operations that are unsupported by the first device.

Example 14 includes the at least one computer readable storage medium of Example 13, wherein the program instructions, when executed, further cause the computing system to prevent access of the first device by the second process, and prevent access of the second device by the first process.

Example 15 includes the at least one computer readable storage medium of Example 13, wherein the program instructions, when executed, further cause the computing system to partition the neural network into the first portion and the second portion based on first capability data associated with the first device and second capability data associated with the second device, and store the first capability data and the second capability data to a registry.

Example 16 includes the at least one computer readable storage medium of Example 13, wherein the first portion of the neural network is to be a first subgraph and the second portion of the neural network is to be a second subgraph.

Example 17 includes the at least one computer readable storage medium of Example 13, wherein the program instructions, when executed, further cause the computing system to compile, by the first process, the first portion of the neural network into a first compilation output that is compatible with the first device, generate a first key based on the first compilation output, compile, by the second process, the second portion of the neural network into a second compilation output that is compatible with the second device, and generate a second key based on the second compilation output.

Example 18 includes the at least one computer readable storage medium of any one of Examples 13 to 17, wherein the first portion of the neural network is to include one or more operations that are unsupported by the second device.

Example 19 includes a method of operating a performance-enhanced computing system, comprising detecting a request by a web application to execute a neural network, dispatching a first portion of the neural network to a first device via a first process, and dispatching a second portion of the neural network to a second device via a second process, wherein the second portion of the neural network includes one or more operations that are unsupported by the first device.

Example 20 includes the method of Example 19, further including preventing access of the first device by the second process, and preventing access of the second device by the first process.

Example 21 includes the method of Example 19, further including partitioning the neural network into the first portion and the second portion based on first capability data associated with the first device and second capability data associated with the second device, and storing the first capability data and the second capability data to a registry.

Example 22 includes the method of Example 19, wherein the first portion of the neural network is a first subgraph and the second portion of the neural network is a second subgraph.

Example 23 includes the method of Example 19, further including compiling, by the first process, the first portion of the neural network into a first compilation output that is compatible with the first device, generating a first key based on the first compilation output, compiling, by the second process, the second portion of the neural network into a second compilation output that is compatible with the second device, and generating a second key based on the second compilation output.

Example 24 includes the method of any one of Examples 19 to 23, wherein the first portion of the neural network includes one or more operations that are unsupported by the second device.

Example 25 includes means for performing the method of any one of Examples 19 to 24.

Thus, technology described herein may therefore improve the user experience with respect to web-based activities in client devices. As DL usages have been emerging in web applications, the technology enables web-based DL workloads to be made more efficient and stable through heterogeneous hardware acceleration.

Embodiments are applicable for use with all types of semiconductor integrated circuit (“IC”) chips. Examples of these IC chips include but are not limited to processors, controllers, chipset components, programmable logic arrays (PLAs), memory chips, network chips, systems on chip (SoCs), SSD/NAND controller ASICs, and the like. In addition, in some of the drawings, signal conductor lines are represented with lines. Some may be different, to indicate more constituent signal paths, have a number label, to indicate a number of constituent signal paths, and/or have arrows at one or more ends, to indicate primary information flow direction. This, however, should not be construed in a limiting manner. Rather, such added detail may be used in connection with one or more exemplary embodiments to facilitate easier understanding of a circuit. Any represented signal lines, whether or not having additional information, may actually comprise one or more signals that may travel in multiple directions and may be implemented with any suitable type of signal scheme, e.g., digital or analog lines implemented with differential pairs, optical fiber lines, and/or single-ended lines.

Example sizes/models/values/ranges may have been given, although embodiments are not limited to the same. As manufacturing techniques (e.g., photolithography) mature over time, it is expected that devices of smaller size could be manufactured. In addition, well known power/ground connections to IC chips and other components may or may not be shown within the figures, for simplicity of illustration and discussion, and so as not to obscure certain aspects of the embodiments. Further, arrangements may be shown in block diagram form in order to avoid obscuring to embodiments, and also in view of the fact that specifics with respect to implementation of such block diagram arrangements are highly dependent upon the platform within which the embodiment is to be implemented, i.e., such specifics should be well within purview of one skilled in the art. Where specific details (e.g., circuits) are set forth in order to describe example embodiments, it should be apparent to one skilled in the art that embodiments can be practiced without, or with variation of, these specific details. The description is thus to be regarded as illustrative instead of limiting.

The term “coupled” may be used herein to refer to any type of relationship, direct or indirect, between the components in question, and may apply to electrical, mechanical, fluid, optical, electromagnetic, electromechanical or other connections. In addition, the terms “first”, “second”, etc. may be used herein only to facilitate discussion, and carry no particular temporal or chronological significance unless otherwise indicated.

As used in this application and in the claims, a list of items joined by the term “one or more of” may mean any combination of the listed terms. For example, the phrases “one or more of A, B or C” may mean A, B, C; A and B; A and C; B and C; or A, B and C.

Those skilled in the art will appreciate from the foregoing description that the broad techniques of the embodiments can be implemented in a variety of forms. Therefore, while the embodiments have been described in connection with particular examples thereof, the true scope of the embodiments should not be so limited since other modifications will become apparent to the skilled practitioner upon a study of the drawings, specification, and following claims.

1-24. (canceled)

25. A performance-enhanced computing system comprising:
a first device;
a second device;
a network controller to obtain remote data in response to one or more requests from a web application;
a processor coupled to the network controller; and
a memory coupled to the processor, wherein the memory includes a set of executable program instructions, which when executed by the processor, cause the computing system to:
detect a request by the web application to execute a neural network;
dispatch a first portion of the neural network to the first device via a first process; and
dispatch a second portion of the neural network to the second device via a second process, wherein the second portion of the neural network is to include one or more operations that are unsupported by the first device.

26. The computing system of claim 25, wherein the program instructions, when executed, further cause the computing system to:
prevent access of the first device by the second process; and
prevent access of the second device by the first process.

27. The computing system of claim 25, wherein the program instructions, when executed, further cause the computing system to:
partition the neural network into the first portion and the second portion based on first capability data associated with the first device and second capability data associated with the second device; and
store the first capability data and the second capability data to a registry.

28. The computing system of claim 25, wherein the first portion of the neural network is to be a first subgraph and the second portion of the neural network is to be a second subgraph.

29. The computing system of claim 25, wherein the program instructions, when executed, further cause the computing system to:
compile, by the first process, the first portion of the neural network into a first compilation output that is compatible with the first device;
generate a first key based on the first compilation output;
compile, by the second process, the second portion of the neural network into a second compilation output that is compatible with the second device; and
generate a second key based on the second compilation output.

30. The computing system of claim 25, wherein the first portion of the neural network is to include one or more operations that are unsupported by the second device.

31. A semiconductor apparatus comprising:
one or more substrates; and
logic coupled to the one or more substrates, wherein the logic is implemented at least partly in one or more of configurable logic or fixed-functionality hardware logic, the logic coupled to the one or more substrates to:
detect a request by a web application to execute a neural network;
dispatch a first portion of the neural network to a first device via a first process; and
dispatch a second portion of the neural network to a second device via a second process, wherein the second portion of the neural network is to include one or more operations that are unsupported by the first device.

32. The semiconductor apparatus of claim 31, wherein the logic coupled to the one or more substrates is to:
prevent access of the first device by the second process; and
prevent access of the second device by the first process.

33. The semiconductor apparatus of claim 31, wherein the logic coupled to the one or more substrates is to:
partition the neural network into the first portion and the second portion based on first capability data associated with the first device and second capability data associated with the second device; and
store the first capability data and the second capability data to a registry.

34. The semiconductor apparatus of claim 31, wherein the first portion of the neural network is to be a first subgraph and the second portion of the neural network is to be a second subgraph.

35. The semiconductor apparatus of claim 31, wherein logic coupled to the one or more substrates is to:
compile, by the first process, the first portion of the neural network into a first compilation output that is compatible with the first device;
generate a first key based on the first compilation output;
compile, by the second process, the second portion of the neural network into a second compilation output that is compatible with the second device; and
generate a second key based on the second compilation output.

36. The semiconductor apparatus of claim 31, wherein the first portion of the neural network is to include one or more operations that are unsupported by the second device.

37. At least one computer readable storage medium comprising a set of executable program instructions, which when executed by a computing system, cause the computing system to:
detect a request by a web application to execute a neural network;
dispatch a first portion of the neural network to a first device via a first process; and
dispatch a second portion of the neural network to a second device via a second process, wherein the second portion of the neural network is to include one or more operations that are unsupported by the first device.

38. The at least one computer readable storage medium of claim 37, wherein the program instructions, when executed, further cause the computing system to:
prevent access of the first device by the second process; and
prevent access of the second device by the first process.

39. The at least one computer readable storage medium of claim 37, wherein the program instructions, when executed, further cause the computing system to:
partition the neural network into the first portion and the second portion based on first capability data associated with the first device and second capability data associated with the second device; and
store the first capability data and the second capability data to a registry.

40. The at least one computer readable storage medium of claim 37, wherein the first portion of the neural network is to be a first subgraph and the second portion of the neural network is to be a second subgraph.

41. The at least one computer readable storage medium of claim 37, wherein the program instructions, when executed, further cause the computing system to:
compile, by the first process, the first portion of the neural network into a first compilation output that is compatible with the first device;
generate a first key based on the first compilation output;
compile, by the second process, the second portion of the neural network into a second compilation output that is compatible with the second device; and
generate a second key based on the second compilation output.

42. The at least one computer readable storage medium of claim 37, wherein the first portion of the neural network is to include one or more operations that are unsupported by the second device.

43. A method of operating a performance-enhanced computing system, comprising:
detecting a request by a web application to execute a neural network;
dispatching a first portion of the neural network to a first device via a first process; and
dispatching a second portion of the neural network to a second device via a second process, wherein the second portion of the neural network includes one or more operations that are unsupported by the first device.

44. The method of claim 43, further including:
preventing access of the first device by the second process; and
preventing access of the second device by the first process.

45. The method of claim 43, further including:
partitioning the neural network into the first portion and the second portion based on first capability data associated with the first device and second capability data associated with the second device; and
storing the first capability data and the second capability data to a registry.

46. The method of claim 43, wherein the first portion of the neural network is a first subgraph and the second portion of the neural network is a second subgraph.

47. The method of claim 43, further including:
compiling, by the first process, the first portion of the neural network into a first compilation output that is compatible with the first device;
generating a first key based on the first compilation output;
compiling, by the second process, the second portion of the neural network into a second compilation output that is compatible with the second device; and
generating a second key based on the second compilation output.

48. The method of claim 43, wherein the first portion of the neural network includes one or more operations that are unsupported by the second device.
